(19) United States
(12) Patent Application Publication
(10) Pub. No.: US 2021/0256392 A1
(43) Pub. Date: Aug. 19, 2021

(54) AUTOMATING THE DESIGN OF NEURAL NETWORKS FOR ANOMALY DETECTION

(71) Applicant: NEC Laboratories America, Inc., Princeton, NJ (US)

(72) Inventors: Zhengzhang Chen, Princeton Junction, NJ (US); Haifeng Chen, West Windsor, NJ (US); Yuening Li, College Station, TX (US)

(21) Appl. No.: 17/170,254

(22) Filed: Feb. 8, 2021

Related U.S. Application Data
(60) Provisional application No. 62/972,192, filed on Feb. 10, 2020.

(51) Int. Cl. G06N 3/08; G06N 3/04

(52) U.S. Cl. CPC G06N 3/088; G06N 3/0472

(57) ABSTRACT

Systems and methods for automatically generating a neural network to perform anomaly detection. The method includes defining a search space, including parameters for neural network architectures, definition-hypothesis of an anomaly assumption, and loss functions, as a tuple, and selecting a first candidate anomaly detection architecture from the search space that defines the parameters of the neural network architecture. The method further includes feeding a data set into the neural network defined by the first and second candidate anomaly detection architectures, and selecting a second candidate anomaly detection architecture from the search space that defines the parameters of the neural network. The method further includes determining a performance difference between the first architecture and the second architecture. The method further includes repeating the defining of the neural network with subsequent candidates, and identifying a best neural network candidate from the search space based on the performance differences.

### RELATED APPLICATION INFORMATION

This application claims priority to Provisional Application No. 62/972,192, filed on Feb. 10, 2020, incorporated herein by reference in its entirety.

### BACKGROUND

### Technical Field

The present invention relates to neural architecture search processes and systems, and more particularly to automated design of neural networks for anomaly detection.

### Description of the Related Art

Anomaly detection focuses on a very small minority of data objects compared to patterns that can apply to majority of objects in the data set. With a random data set, there is no guarantee of finding anomalies, either because there may not be a suitable test for the type of anomaly, or because no standard distribution can adequately model the observed distribution. To fit the observed distributions into standard distributions, and to choose suitable tests, requires non-trivial computational effort for large data sets. Deep neural networks may be adapted for anomaly detection.

### SUMMARY

According to an aspect of the present invention, a computer implemented method is provided for automatically generating a neural network to perform anomaly detection. The method includes defining a search space, including parameters for neural network architectures, definition-hypothesis of an anomaly assumption, and loss functions, as a tuple, and selecting a first candidate anomaly detection architecture from the search space that defines the parameters of the neural network architecture. The method further includes feeding a data set into the neural network defined by the first candidate anomaly detection architecture, wherein the data set includes recognized anomalies for a specified anomaly detection task, and selecting a second candidate anomaly detection architecture from the search space that defines the parameters of the neural network. The method further includes feeding the data set into the neural network defined by the second candidate anomaly detection architecture, and determining a performance difference between the neural networks defined by the first candidate anomaly detection architecture and the neural network defined by the second candidate anomaly detection architecture based on the data set. The method further includes repeating the defining of the neural network with subsequent candidates of anomaly detection architectures selected from the search space, and identifying a best anomaly detection neural network candidate selected from the search space based on the performance differences for the data set of the specified anomaly detection task.

According to another aspect of the present invention, a processing system for automatically generating a neural network to perform anomaly detection. The processing system includes one or more processor devices, a memory in communication with at least one of the one or more processor devices, and an automated anomaly detection (AutoAD) framework configured to defining a search space, including parameters for neural network architectures, definition-hypothesis of an anomaly assumption, and loss functions, as a tuple, and select a first candidate anomaly detection architecture from the search space that defines the parameters of the neural network architecture. The automated anomaly detection (AutoAD) framework configured to feed a data set into the neural network defined by the first candidate anomaly detection architecture, wherein the data set includes recognized anomalies for a specified anomaly detection task, and select a second candidate anomaly detection architecture from the search space that defines the parameters of the neural network. The automated anomaly detection (AutoAD) framework configured to feed the data set into the neural network defined by the second candidate anomaly detection architecture, and determine a performance difference between the neural networks defined by the first candidate anomaly detection architecture and the neural network defined by the second candidate anomaly detection architecture based on the data set. The automated anomaly detection (AutoAD) framework configured to repeat the defining of the neural network with subsequent candidates of anomaly detection architectures selected from the search space, and identify a best anomaly detection neural network candidate selected from the search space based on the performance differences for the data set of the specified anomaly detection task.

According to yet another aspect of the present invention, a non-transitory computer readable storage medium comprising a computer readable program for producing a neural network for anomaly detection is provided, wherein the computer readable program when executed on a computer causes the computer to perform defining a search space, including parameters for neural network architectures, definition-hypothesis of an anomaly assumption, and loss functions, as a tuple, and selecting a first candidate anomaly detection architecture from the search space that defines the parameters of the neural network architecture. The computer readable program also causes the computer to perform feeding a data set into the neural network defined by the first candidate anomaly detection architecture, wherein the data set includes recognized anomalies for a specified anomaly detection task, and selecting a second candidate anomaly detection architecture from the search space that defines the parameters of the neural network. The computer readable program also causes the computer to perform feeding the data set into the neural network defined by the second candidate anomaly detection architecture, and determining a performance difference between the neural networks defined by the first candidate anomaly detection architecture and the neural network defined by the second candidate anomaly detection architecture based on the data set. The computer readable program also causes the computer to perform repeating the defining of the neural network with subsequent candidates of anomaly detection architectures selected from the search space, and identifying a best anomaly detection neural network candidate selected from the search space based on the performance differences for the data set of the specified anomaly detection task.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level system/method for an automated anomaly detector (AutoAD) with a search space and dataset is illustratively depicted, in accordance with one embodiment of the present invention;

FIG. 2 is a diagram illustrating an AutoAD with two layers applied to a search space, in accordance with an embodiment of the present invention;

FIG. 3 is an exemplary processing system 400 to which the present methods and systems may be applied, in accordance with an embodiment of the present invention;

FIG. 4 is an exemplary processing system configured to implement one or more neural networks for automating the design of neural networks for anomaly detection, in accordance with an embodiment of the present invention; and

FIG. 5 is a block diagram illustratively depicting an AutoAD neural network in accordance with another embodiment of the present invention.

### DETAILED DESCRIPTION OF PREFERRED EMBODIMENTS

In accordance with embodiments of the present invention, systems and methods are provided for automating the design of neural networks for anomaly detection. In one or more embodiments, an automated anomaly detection framework is provided to find an optimal neural network model architecture for a given dataset. Reinforcement learning and evolution can be used to discover optimal model architectures for anomaly detection from large datasets. Anomalies refer to the objects with patterns or behaviors that are significantly rare and different from the rest of the majority of data. An effective neural architecture search (NAS) algorithm can involve two components: the search space, and the search strategy, which determine what architectures can be represented in principles, and how to explore the search space, respectively. It can be non-trivial to determine the search space for an anomaly detection task. The search space of automated anomaly detection (AutoAD) needs to cover not only the architecture configurations, but also the anomaly definitions with corresponding objective functions. Since there may be no class label information in the training data of an anomaly detection task, objective functions can play an important role in differentiating between normal and anomalous behaviors. And in contrast to supervised learning tasks, a suitable definition of the anomaly and its corresponding objective function may need to be found for a given real-world data set. The neural architectures discovered by NAS have been demonstrated to be on par with or outperforms hand-crafted neural network architectures.

Anomaly detection can play an important role in various applications and fields, such as fraud detection, cyber security, medical diagnosis, and industrial manufacturer. Anomaly detection methods can depend on their hyper-parameter settings including the number of layers, size of kernels and filters, etc. Classifiers can be trained to weigh anomalies less heavily to avoid overfitting training data; however, this can make anomaly detection much more difficult. Neural networks designed for anomaly detection would therefore be different from such classifiers. There is currently no single anomaly detection algorithm that outperforms all others on all scenarios, since many anomaly detection techniques were specifically developed for certain application domains. This can make it challenging and expensive to apply anomaly detection to tackle real-world problems.

Embodiments of the present invention can help novices select an optimum architecture for an anomaly detector neural network. The embodiments can automatically search for a suitable anomaly detection solution with architecture configurations for different given tasks on hand. There may be a narrow architecture space for anomaly detection that can provide an optimal solution. In various embodiments, a search space, A_{ω}^{J}, can include three (3) components, as a Triplet (A, H, L), where optimum values for A, H, and L can be determined. “A” can be a targeted architecture, for example, a convolutional deep neural network or an Autoencoder deep neural network with corresponding detailed configurations. “H” can be a hypothesis. “L” can be a Loss Function design. “H” and “L” can be global parameters of that particular architecture. In various embodiments, the model of anomaly detection can include three particular components: the neural network architecture A of an AutoEncoder, the definition-hypothesis H of an anomaly assumption, and the loss function L, which can be represented in the model as the Triple (A; H; L). The triple (A; H; L) can denote the search space for the anomaly detection models, where A denotes the architecture subspace, H denotes the definition hypothesis subspace, and L denotes the loss functions subspace. Given training set Dₜᵣₐᵢₙ and validation set D_{valid}, where the aim is to find the optimal model (A*; H*; L*) that minimizes an objective function, J.

The neural architecture search (NAS) problem looks to find the optimal neural architecture in a predefined search space to maximize the model performance on a user selected task. A contribution lies in the design of the search space for the specific neural architectures, for example, by searching the convolutional kernels and skip connections, the architecture of convolutional neural networks (CNNs) can be optimized to improve image classification accuracy.

In various embodiments, an automated anomaly detection (AutoAD) procedure (framework) is provided by the Combined Architecture Search and Hyperparameter with Notion-space optimization (CASHNO). The automated anomaly detection procedure can formulate the search process as a joint optimization problem. Automated machine learning (AutoML) can be incorporated into an unsupervised settings for anomaly detection, and extends automated machine learning concepts into real world data mining tasks. A neural network can explore a search space, as a meta-learning process.

In various embodiments, a long short term memory (LSTM) based controller can be used to sample a strategy, S, and update the parameters, θ, of the controller with the reward, R, with the pre-defined search space and the given dataset. This can include search space design, a search algorithm as the search strategy, and the reward shaping for the downstream tasks.

In various embodiments, a search space can be designed for an anomaly detection pipeline, which can be composed of a notion-space of anomaly definitions, pre-processing methods, layers of auto-encoder based structures, and loss function designs. A notion-space can be the constructs of what constitutes an anomaly for a specific data domain. The search can be a curiosity guided search that avoids local optima, stabilizes the search process, and can improve search effectiveness. An experience replay mechanism based on self-imitation learning can improve the sample efficiency.

In various embodiments, a (6N+3) element tuple can be used to represent the pipeline configurations, where N is the number of layers in the encoder-decoder-wise structure. For a global configuration, a notion concept can determine the way to define the “anomalies” from a high-level perspective, including classification based, density based, cluster based, centroid based, and reconstruction based assumptions. Pre-processing can relate to the pre-processing methods, for example, augmentations, including translation, rotation, equalize, solarize, sharpness, brightness, auto-contrast and shearing. Distance measurement relates to the matrix for measuring the distance for the reconstruction purpose, including L1 norm, L2 norm, L2,1 norm, and the structural similarity (SSIM).

For a local configuration in each layer, an output channel can denote the number of channels produced by the convolution operations in each layer, for example, 3, 8, 16, 32, 64, 128, 256, etc.

Convolution Kernel can denote the size of the kernel produced by the convolution operations in each layer, for example, 1×1, 3×3, 5×5, 7×7. The kernel size can be different for each layer.

Pooling Type can denote the type of pooling in each layer, including the max pooling and the average pooling.

Pooling Kernel can denote the kernel size produced by the pooling operations in each layer, for example, 1×1, 3×3, 5×5, 7×7.

Normalization type can denote the normalization type in each layer, including three options: batch normalization, instance normalization, and no normalization.

Activation function is a set of activation functions in each layer, including, but not limited to, Sigmoid, Tanh, ReLU, Linear, Softplus, LeakyReLU, ReLU6, and ELU.

Representative Anomaly Detection Notions:

$$DENSITY \text{:} - log ( {\sum }_{k = 1}^{K} {\hat{ϕ}}_{k} \frac{{exp ( - \frac{1}{2} ( f ( {x}_{i} \text{;} ω ) - {\hat{μ}}_{k} ) )}^{T} {\sum }_{k}^{- 1} ( f ( {x}_{i} \text{;} ω ) - {\hat{μ}}_{k} )}{\sqrt{\vert 2 π {\hat{Σ}}_{k} \vert}} ) ;$$

where ω denotes the parameters in the network. x denotes the input. “i” is an index over the inputs. \hat{μ}ₖ, \hat{ϕ}, Σₖ denote the mixture probability, mean, and covariance for component k in the Gaussian Mixture Model (GMM). K denotes the number of components in GMM.

$$CLUSTER \text{:} {Σ}_{i} {Σ}_{j} {p}_{ij} log {{p}_{ij} ( \frac{{( 1 + {‖ f ( {x}_{i} ; ω ) - {μ}_{j} ‖}^{2} )}^{- 1}}{{{Σ}_{f} ( 1 + {‖ f ( {x}_{i} ; ω ) - {μ}_{j} ‖}^{2} )}^{- 1}} )}^{- 1}$$

where ω denotes the parameters in the network, x denotes the input, and μ denotes the mean of the clusters. F denotes the number of clusters.

CENTROID: R²+Σᵢ₌₁ⁿmax{0,∥f(xᵢ;ω)−c∥²−R²}

where “R” is a radius, “c” is a centroid, “i” is an index over the inputs, and “n” is the number of all samples in the training set.

$$RECONSTRUCTION \text{:} \frac{1}{n} {\sum }_{i = 1}^{n} {‖ g ( f ( {x}_{i} \text{;} ω ) ) - {x}_{i} ‖}_{2}^{2} ;$$

where “f” is the encoder function, “g” is the decoder function, and the two 2s represent the squared L2 norm, ω denotes the parameters in the network, x denotes the input, and n denotes the number of the input samples.

In various embodiments, the search space can include an exponential number of configurations.

In a nonlimiting exemplary embodiment, if the encoder-decoder cell has N layers and the action classes as above, this provides 4×8×(7×4×2×4×3×8)N×4 possible configurations. Supposing N=6, the number of possible solutions within a search space is 3.09e+24, which requires an efficient search strategy to find an optimal solution out of the search space.

In various embodiments, a deep autoencoder is composed of two, symmetrical deep-belief networks that typically have four or five shallow layers representing the encoding half of the network, and a second set of four or five layers that make up the decoding half of the network, where the layers can be restricted Boltzmann machines (RBM). RBMs are shallow, two-layer neural nets that constitute the building blocks of deep-belief networks. The first layer of the RBM is called the visible, or input, layer, and the second layer is a hidden layer. The encoding half of the Autoencoder can encode the input data using an RBM. The decoding half of a deep autoencoder is the part that learns to reconstruct the original data using back propagation and reconstruction error(s). The AutoEncoder learns a representation by minimizing the reconstruction error from the normal samples (e.g., original data). Deep autoencoders can be trained to extract common factors from the majority of data points as normal behaviors, while anomalous samples contain a large reconstruction error from the normal samples.

In various embodiments, the AutoEncoder learns a representation by minimizing the reconstruction error from normal samples. Therefore, it can be used to extract the common factors of variation from normal samples and reconstruct them easily, and vice versa.

Density based approaches can estimate the relative density of each sample, and declare instances that lie in a neighborhood with low density as anomalous.

With the clustering based assumption, normal data instances belong to an existing cluster in the data, while anomalies do not belong to any cluster.

Centroid based approaches can rely on the assumption that normal data instances lie close to their closest cluster centroid, while anomalies are far away from the centroid(s).

In various embodiments, the Combined Architecture Search with Hyperparameters and Notion-space hypothesis Optimization (CASHNO) problem is to find the joint algorithm and hyperparameter setting corresponding to specific notion settings that minimizes the loss as:

$${A}^{*} , {H}^{*} , {L}^{*} ∈ 𝒥 ( A ( ω ) , H , L , {D}_{train} , {D}_{valid} ) ,$$

where ω denotes the weights well trained on architecture A. [symbol] denotes the loss on D_{valid} using the model trained on the Dₜᵣₐᵢₙ with definition-hypothesis, H, and loss function, L.

In various embodiments, an automated anomaly detection framework to find the optimal neural network (child) model for a given dataset is provided. Given the optimization problem, a tailored framework to facilitate the design of an anomaly detection system is provided. A general search space is designed to include the neural architecture hyperparameters, definition-hypothesis, and objective functions.

The search process, however, may become unstable and fragile when anomaly detection is compounded with an architecture search. On the one hand, the imbalanced data distributions can make the search process easily fall into the local optima, and on the other hand, internal mechanisms of the traditional NAS may introduce bias in the search process. To overcome the difficulties of local optimality under certain unstable search circumstances, a curiosity-guided search strategy is presented to improve search effectiveness. An experience replay mechanism (e.g., buffers) based on self-imitation learning is presented to better exploit the past good experience and enhance the sample efficiency. An automated anomaly detection (AutoAD) algorithm can be used to find an optimal deep neural network model for a given dataset using a comprehensive search space specifically tailored for anomaly detection.

In various embodiments, the search space can encompass architecture settings, anomaly definitions, and corresponding loss functions. Because there is a lack of intrinsic search space for anomaly detection tasks, the search space can be designed for the Deep AutoEncoder based algorithms, which is composed of global settings for the whole network model, and local settings in each layer independently.

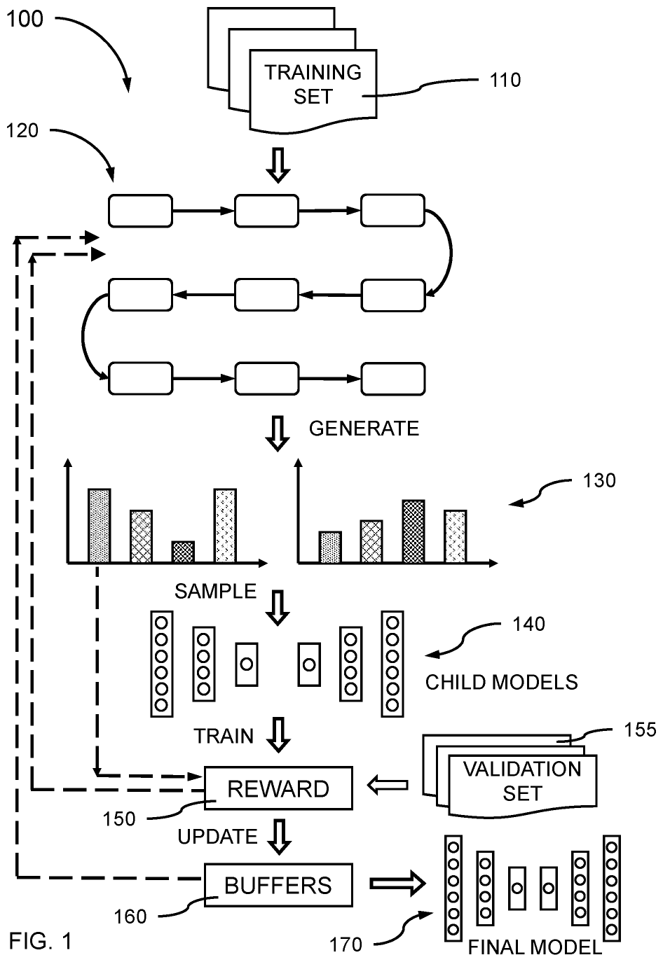

Referring now in detail to the figures in which like numerals represent the same or similar elements and initially to FIG. 1, a high-level system/method for an automated anomaly detector with a search space and dataset is illustratively depicted, in accordance with one embodiment of the present invention.

An automated anomaly detection framework 100 to find the optimal neural network model for a given dataset is proposed. In various embodiments, the first part of an AutoAD framework 100 is a training set 110, also referred to as Dₜᵣₐᵢₙ. A second part is a controller 120, which can be a long short term memory (LSTM) controller. The third part are the actions 130, including global and local settings, generated by the controller 120. The fourth part are child models 140 that can become a candidate anomaly detection architecture after an evaluation. The fifth part is the calculated reward values 150 used to evaluate the sampled child models 140. The sixth part is the experience relay buffers 160 that store past reward values 150, and can feed the reward values back to the controller 120. The seventh part is the best sample anomaly detection candidate 170 selected from the search space based on a loss function, a validation set, D_{valid}, and experience replay buffers 160.

In various embodiments, global settings and local settings in each layer are defined in the search space, including definition-hypothesis, distance measurement, output channels, convolution kernels, pooling types, pooling kernels, normalization types and activation function. With the pre-defined search space and the given dataset, an LSTM based controller can be used to generate actions, a. Child models 140 are sampled from actions, a, 130 and evaluated with the reward, r, 150, where child models are a batch of new models sampled from the controller as new candidate architectures. Once the search process of one iteration is done, the controller 120 can sample M child models as candidate architectures and then pick the top K from them. The top K candidate architectures' controller outputs can be fed as the input into the next iteration's controller 120. To find the optimal architecture, the controller 120 can maximize its expected reward r, which is the expected performance in the validation set 155 of the proposed trajectories. Parameters, θ, of the controller 120 are updated based on the reward 150. The reward 150 can be shaped by information maximization about the controller's internal belief of the model, which is designed to guide the search process. Good past experiences evaluated by the reward function can be stored in experience replay buffers 160 for future self-imitations through the controller 120. A neural architecture in the Autoencoder needs to be adaptive in the given dataset to achieve competitive performance.

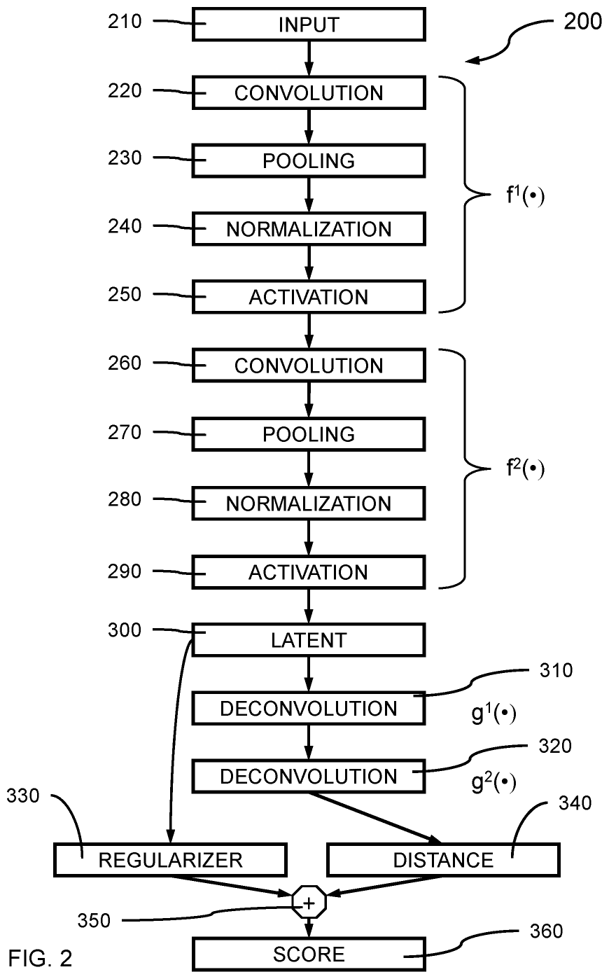

FIG. 2 is a diagram illustrating an AutoAD with two layers applied to a search space, in accordance with an embodiment of the present invention.

In various embodiments, an AutoAD 200 can include two (2) layers, f¹(⋅) and f²(⋅), where f¹(⋅) can have a convolution layer 220, a pooling layer 230, a normalization layer 240 and an activation layer 250, and f²(⋅) can have a convolution layer 260, a pooling layer 270, a normalization layer 280 and an activation layer 290. The AutoAD 200 can also include two Deconvolution layers 310, 320 (g¹(⋅) and g²(⋅)). A Regularizer 330 can be applied to the output of the second layer, f²(⋅), (i.e., the latent-space representation 300), and a Distance measurement 340 can be applied to the output of the deconvolution layer 320. The encoder of the network can compress the input into a latent-space representation through AutoAD 200. The values from the Regularizer 330 and Distance measurement 340 can be combined by combiner 350 to generate a score 360 for a child model trained and tested on the datasets. The Regularizer 330 and Distance measurement 340 can work together to calculate a loss/anomaly score, where mathematically the loss is the sum of the distance measurement and the regularizer values.

In various embodiments, input 210, for example, the testing dataset and validation dataset, can be fed into the convolution layer 220 of f¹(⋅) of the AutoAD 200 to find an optimal deep neural network model for the given dataset(s) input 210.

A non-limiting exemplary embodiment of a search space in AutoAD with two layers, f¹(⋅) and F²(⋅), can be composed of global settings (e.g., Regularizer 330, Distance 340) for the whole model, and local settings (e.g., Convolution, Pooling, Normalization, and Activation) in each layer (f¹(⋅), F²(⋅)), respectively. The building blocks can be wired together to form a direct acyclic graph. Experimental results based on various real-world benchmark datasets demonstrate that the deep model identified by AutoAD achieves superior performance, compared to existing handcrafted models and traditional search methods. When tested on the two important anomaly detection tasks—instance-level abnormal sample detection and pixel-level defect region segmentation—the algorithm demonstrated superior performance, compared with existing handcrafted models and traditional search methods.

In various embodiments, the designed search space for AutoAD, can be composed of the notion-space of anomaly definitions, pre-processing methods, layers of auto-encoder based structures and loss function designs. A (6N+2) element tuple can be used to represent the architecture configurations, where N is the number of layers in the encoder-decoder-wise structure.

A={f¹(⋅), . . . ,f^{N}(⋅),g¹(⋅), . . . ,g^{N}(⋅)}; where

fⁱ(x; ω)=ACT(NORMA(POOL(CONV(x))),

gⁱ(x; ω)=ACT(NORMA(UPPOOL(DECONV(f(x)))),

score=DIST(g(f(x;ω)), x)+DEFINEREG(f(x;ω)),

where x denotes the set of instances as input data, and ω denotes the trainable weight matrix. The architecture space A contains N encoder-decoder layers. f(⋅) and g(⋅) denote encoder and decoder functions, respectively. ACT(⋅) is the activation function set. NORMA denotes the normalization functions. POOL(⋅) and UPPOOL(⋅) are pooling methods. CONV(⋅) and DECONV(⋅) are convolution functions. The encoder-decoder based anomaly score “score” contains two terms: a reconstruction distance and an anomaly regularizer. DIST(⋅) is the metric to measure the distance between the original inputs and the reconstruction results. DEFINEREG(⋅) acts as a regularizer to introduce the definition-hypothesis from H. The anomaly detection hypotheses and their mathematical formulas can be extracted from state-of-the-art approaches as shown by:

$$DENSITY \text{:} - log ( {\sum }_{k = 1}^{K} {\hat{ϕ}}_{k} \frac{{exp ( - \frac{1}{2} ( f ( {x}_{i} \text{;} ω ) - {\hat{μ}}_{k} ) )}^{T} {\sum }_{k}^{- 1} ( f ( {x}_{i} \text{;} ω ) - {\hat{μ}}_{k} )}{\sqrt{\vert 2 π {\hat{Σ}}_{k} \vert}} ) ;$$

$$CLUSTER \text{:} {Σ}_{i} {Σ}_{j} {p}_{ij} log {{p}_{ij} ( \frac{{( 1 + {‖ f ( {x}_{i} ; ω ) - {μ}_{j} ‖}^{2} )}^{- 1}}{{{Σ}_{f} ( 1 + {‖ f ( {x}_{i} ; ω ) - {μ}_{j} ‖}^{2} )}^{- 1}} )}^{- 1} ;$$

$$CENTROID \text{:} {R}^{2} + {\sum }_{i = 1}^{n} max \{ 0 , {‖ f ( {x}_{i} \text{;} ω ) - c ‖}^{2} - {R}^{2} \} ;$$

The Search Space described by Density, Cluster, and Centroid can be decomposed into eight (8) classes of actions, a, including Global Settings for the architecture and Local Settings for each layer.

Definition-hypothesis determines the way to define the “anomalies”, which acts as a regularization term in the objective functions. Density-based, Cluster based, Centroid-based, and Reconstruction-based assumptions, are considered, as shown in the equations above.

Distance measurement stands for the matrix measuring the distance for the reconstruction purpose, including l₁, l₂, l_{2,1} norms, and the structural similarity (SSIM).

Local Settings can include:

Output channel is the number of channels produced by the convolution operations in each layer, i.e., 3, 8, 16, 32, 64, 128, and 256.

Convolution kernel denotes the size of the kernel produced by the convolution operations in each layer, i.e., 1×1; 3×3; 5×5; and 7×7.

Pooling type denotes the type of pooling in each layer, including the max pooling and average pooling.

Pooling kernel denotes the kernel size of pooling operations in each layer, i.e., 1×1; 3×3; 5×5; and 7×7.

Normalization type denotes the normalization type in each layer, including three options: batch normalization, instance normalization, and no normalization.

Activation function is a set of activation functions in each layer, including Sigmoid, Tanh, ReLU, Linear, Softplus, LeakyReLU, ReLU6, and ELU.

In various embodiments, a (6N+2) element tuple can be used to represent the model, where N is the number of layers in the encoder-decoder-wise structure. The search space can include an exponential number of settings. Specifically, if the encoder-decoder cell has N layers and there are action classes as above, it provides 4×4×(7×4×2×4×3×8) N possible settings. Suppose N=6, the number of points in the search space is 3.9e+23, which requires an efficient search strategy to find an optimal model out of the large search space.

In various embodiments, a notion concept determines the way to define the “anomalies” from a high-level perspective, including classification based, density based, cluster based, centroid based, and reconstruction based assumptions.

In various embodiments, a two layer search space 200 can be utilized to search for an optimal neural network model within a predefined search space and for the process of building an effective deep learning based system for anomaly detection.

After defining the search space, a search strategy for an optimal model within the search space can be a meta-learning process. A controller can be introduced to explore a given search space by training a network in the inner loop to get an evaluation for guiding exploration, where the controller can be implemented as a recurrent neural network. The controller can be used to generate a trajectory as a sequence of tokens. In various embodiments, the whole process can be treated as a reinforcement learning problem with an action a_{1:T}, and a reward function, r. In various embodiments, the whole process can be treated as a Markov decision process (MDP), defined by A∈R with m an action set, and r as a bounded reward function.

To find an optimal child model, the controller can maximize an expected reward, r, which is an expected performance with a validation dataset, of the child models.

In various embodiments, there can be two sets of learnable parameters: one of them is the shared parameters of the child models, denoted by ω, and the other set is parameters from the controller recurrent neural network (RNN) denoted by θ. “ω” can be optimized using stochastic gradient descent (SGD) with the gradient ∇ω as:

∇_{ω} [symbol] _{m-π(m;θ)}[L(m;ω)]≈∇_{ω}L(m;ω);

where a child model, m, is sampled from the controller's policy π(m; θ), L(m,ω) is the standard cross-entropy loss, computed on a minibatch of training data. The gradient can be estimated using the Monte Carlo method, since a reward calculation may be non-differentiable.

In various embodiments, a Monte Carlo method can be used to approximate the gradient by use of sampling methods from the training set, since the expectation cannot be derived analytically. The original expectation can be described by ∇_{ω} [symbol] _{m-π(m;θ)}[L(m; ω)], and the approximated expectation can be described by ∇_{ω}L(m; ω). To maximize the expected reward r, ω can be fixed, and a REINFORCE rule can be applied to update the controller's parameters, θ, as:

∇_{θ} [symbol] _{p(a1:T;θ)}[r∇_{θ} log P(aₜ|a_{1:t-1};θ)]

where r is computed as the performance or accuracy on the validation set, D_{valid}, rather than on the training set, Dₜᵣₐᵢₙ. To find the optimal model, the controller maximizes its expected reward, r, which is the expected performance of the child models with the validation set.

An empirical approximation of ∇_{θ} above is:

$$L = \frac{1}{n} {\sum }_{k = 1}^{n} {\sum }_{t = 1}^{T} ( {r}_{k} - b ) {∇}_{θ} log P ( {a}_{t} \text{\textbar} {a}_{1 \text{:} t - 1} \text{;} θ ) ,$$

where n is the number of different child models that the controller samples in one batch and T is the number of tokens. Tokens are the length of each trajectory. Each token is one specific setting predefined in the search space. The controller can generate a trajectory as a sequence of tokens. b acts as a baseline function to reduce estimated variances.

Despite being widely utilized due to searching efficiency, weight sharing approaches are roughly built on empirical experiments instead of solid theoretical ground. It is due to an unfair bias that the controller misjudges child-model performance: those who have better initial performance with similar trajectories are more likely to be sampled. In the meanwhile, due to an imbalance in label distribution in anomaly or anomaly detection tasks, it is easy to have the controller fall into a local optima.

To solve the problem above, the AutoAD method builds on the theory of curiosity-driven exploration, aiming to encourage the agent to seek out regions in the search spaces that are relatively unexplored. Bayesian reinforcement learning can offer formal guarantees as a coherent probabilistic model for reinforcement learning. It provides a principled framework to express the classic exploration-exploitation dilemma, by keeping an explicit representation of uncertainty, and selecting actions that are optimal with respect to a version of the problem that incorporates this uncertainty. In various embodiments, a Bayesian LSTM can be used as the structure of the controller to guide the search, rather than a vanilla recurrent neural network. The controller's understanding of the search space is represented dynamically over the uncertainty of the parameters of the controller. Assuming a prior p(θ), it maintains a distribution prior over the controller's parameters through a distribution over θ. The controller models the actions via p(aₜ|a_{1:t}; θ), parameterized by θ.

In various embodiments, a list of tokens that the controller predicts can be viewed as a list of actions a_{1:T} to design an architecture for a child network. The agent can model the actions via p(aₜ∪a_{1:t}; θ), parameterized by the random variables θ. The uncertainty about the dynamics of the search agent can be interpreted as the information gain between a search agent's new belief compared to an old one. According to curiosity-driven exploration, the uncertainty about the controller's dynamics can be formalized as maximizing the sum of reductions to maximize the information:

I(aₜ;θ|a_{1:t-1})= [symbol] _{at˜P}(⋅|a_{1:t-1)}[D_{KL}[p(θ|a_{1:t-1})∥p(θ)]],

where the KL divergence can be interpreted as information gain, which denotes the mutual information between the controller's new belief over the model to the old one.

In various embodiments, the information gain of the posterior dynamics distribution of the controller can be approximated as an intrinsic reward, which captures the controller's surprise in the form of a reward function. The information gain can be used to quantify the difference between the new action with the old actions. We aim to encourage the agent to explore more unsearched places in the search space. The individual terms equal the mutual information between the next action distribution and the model parameter, namely I( ). Therefore, the agent is encouraged to take actions that lead to actions that are maximally informative about the dynamics model.

Thus, the information gain of the posterior dynamics distribution of the controller can be approximate as an intrinsic reward, which captures the agent's surprise in the form of a reward function. We can also use the REINFORCE rule to approximate planning for maximal mutual information by adding the intrinsic reward along with the external reward (accuracy on the validation dataset) as a new reward function. It can also be interpreted as a trade-off between exploitation and exploration as:

r_{new}(aₜ)=r(aₜ)+ηD_{KL}[p(θ|a_{1:t-1})∥p(θ)]

where η∈R₊ is a hyperparameter controlling the urge to explore, and where aₜ denotes the action at the time t, a_{1:t-1} denotes the previous actions from time 1 to t−1, and p(θ) denotes a prior density. However, it is generally intractable to calculate the posterior p(θ|a_{1:t-1}).

In various embodiments, comparing with the old reward function, the new reward function adds a new regularizer to encourage the controller to explore more unsearched places in the search space. The regularizer can capture the controller's surprise comparing with old actions.

Here, a tractable solution is provided to maximize the information gain objective presented in the previous subsection. To learn a probability distribution over network parameters, θ, a practical solution through a back-propagation compatible algorithm is proposed, Bayes-by-backprop.

In Bayesian models, latent variables are drawn from a prior density p(θ). During inference, the posterior distribution p(θ|x) is computed given a new action through Bayes' rule as:

$$p ( {a}_{t} \text{\textbar} {a}_{1 \text{:} t - 1} ) = \frac{p ( θ ) p ( {a}_{t} \text{\textbar} {a}_{1 \text{:} t - 1} ; θ )}{p ( {a}_{t} \text{\textbar} {a}_{1 \text{:} t - 1} )} ,$$

where aₜ denotes the action at the time t, a_{1:t-1} denotes the previous actions from time 1 to t−1, and p(θ) denotes a prior density, where latent variables are drawn from.

The denominator can be computed through the integral:

p(aₜ|aₜ₋₁)=∫_{θ}(aₜ|a_{1:t-1};θ)p(θ)dθ

As controllers are highly expressive parametrized neural networks, for example, an LSTM, which are usually intractable as high-dimensionality. Instead of calculating the posterior p(θ|Dₜᵣₐᵢₙ) for a training dataset Dₜᵣₐᵢₙ, the posterior can be approximated through alternative probability densities over the latent variables θ as q(θ), by minimizing the Kullback-Leibler (KL) divergence:

D_{KL}[q(θ;ϕ)∥p(θ)],

q(θ;ϕ)=Πₗ₌₁^{|Φ|N(θ}ᵢ|μᵢ;σᵢ²), ϕ={μ,σ}

q(θ) is given by a Gaussian distribution, with μ as the Gaussian's mean vector and a as the covariance matrix. The KL divergence, q(θ), can act as the variational posterior, which is the approximation to the true posterior. N(⋅) denotes the normal distribution, with respect to the mean (mu) and the variance (sigma).

To make the calculation convenient, let BNN weight distribution q(θ;ϕ) be given by the fully factorized Gaussian distribution ϕ, with μ the Gaussian's mean vector and a the covariance matrix diagonal. So that it allows a simple analytical formulation of the KL divergence. Once solved, q(⋅) would be the closest approximation to the true posterior. Let log p(D|θ) be the log-likelihood of the model, the network can be trained by minimizing the variational free energy as the expected lower bound:

L[q(θ),D]=− [symbol] _{θ˜q(⋅)}[log p(D|θ)]+D_{KL}[q(θ)∥p(θ)],

which can be approximated using N Monte Carlo samples from the variational posterior with N samples drawn according to 0 q(⋅):

L[q(θ),D]≈Σᵢ₌₁^{N}−log p(D|θⁱ)+log q(θ⁽ⁱ⁾)−log p(θ⁽ⁱ⁾).

We want to minimize the KL divergence between the approximation q and the posterior p. While this quantity for the KL divergence cannot actually be minimized, a function that is equal to it up to a constant can be minimized. This function is known as the evidence lower bound (ELBO), where the “evidence” is a term used for the marginal likelihood of observations.

We discuss how to derive a distribution q(θ|D) to improve the gradient estimates of the intractable likelihood function p(D), which is related to Variational AutoEncoders (VAEs). The “sharpened” posterior yields more stable optimization. We now use posterior sharpening strategy to benefit our search process.

The challenging part of modelling the variational posterior q(θ|D) is the large number of dimensions of θ∈ [symbol] ^{d}, which makes the modelling unfeasible. Given the first term of the loss −log p(D|θ) is differentiable with respect to θ, we propose to parameterize q as a linear combination of θ and −log p(D|θ). Thus, the hierarchical posterior of the form can be defined:

q(θ|D)=∫q(θ|ϕ,D)q(θ)dθ;

q(θ|ϕ,D)=N(θ|ϕ−η*−∇_{ϕ}p(D|ϕ),σ₀²I);

where μ, σ∈ [symbol] ^{d} and q(ϕ)=N(θ|μ, σ) as the same setting in the standard variational inference method. η∈ [symbol] ^{d} can be treated as a per-parameter learning rate.

In the training phrase, we have θ˜q(θ|D) via ancestral sampling to optimize the loss as:

[symbol]

Lₑₓₚₗₒᵣₑ=L(μ,σ,ζ)= [symbol] _{D}[ [symbol] _{q(ϕ)q(θ|ϕ,D)}[L(D,θ,ϕ|μ,σ,η)]]

with L(D, θ, ϕ|μ, σ, η) given by:

$$L ( D , θ , ϕ \text{\textbar} μ , σ , η ) = - log p ( D \text{\textbar} θ ) + KL [ q ( θ \text{\textbar} ϕ , D ) ‖ p ( θ \text{\textbar} ϕ ) ] + \frac{1}{c} KL [ q ( ϕ ) ‖ p ( ϕ ) ] ,$$

where the constant C is the number of truncated sequences.

Thus, we turn to deriving the training loss function for posterior sharpening. With the discussion above, we assume a hierarchical prior for the parameters such that:

p(D)=∫p(D|θ)p(θ|ϕ)p(ϕ)dθdϕ.

The expected lower bound on p(D) is then as follows:

$$log p ( D ) = log ( \int p ( D \text{\textbar} θ ) p ( θ \vert ϕ ) p ( ϕ ) d θ d ϕ ) \geq {𝔼}_{q ( ϕ , θ \vert D )} [ log \frac{p ( D \text{\textbar} θ ) p ( θ \text{\textbar} ϕ ) p ( ϕ ) d θ d ϕ}{q ( ϕ , θ \text{\textbar} D )} ] = {𝔼}_{q ( ϕ )} [ {𝔼}_{q ( θ \vert ϕ , D )} [ log p ( D \text{\textbar} θ ) - KL [ q ( θ \text{\textbar} ϕ , D ) ‖ p ( θ \text{\textbar} ϕ ) ] ] - KL [ q ( ϕ ) ‖ p ( ϕ ) ] ] .$$

In various embodiments, a bound on a Bayesian model average over the approximate posterior of ϕ can also be derived as a derivation of predictions as:

[symbol]

_{q(ϕ)}[log p(\hat{x}|ϕ)]= [symbol] _{q(ϕ)}[ [symbol] _{q(θ|ϕ,x)}[log p(\hat{x}|θ)−KL[q(θ|ϕ,x)∥p(θ|ϕ)]]]

The goal of this section is to exploit the past good experiences for the controller to find a potential better policy. In this paper, we propose to store rewards from historical episodes into a replay buffer: B=(a_{1:t}, rₐ), where a_{1:t}, and rₐ are the action and the corresponding reward at time-step t. Exploiting good past experiences can be beneficial for the controllers, so an experience replay buffer can be updated for child models with better rewards, and amplify the contribution from them to the gradient of θ. More specifically, child models from the replay buffer can be sampled using the clipped advantage (r−b)₊, where the rewards, r, in the past experiences outperform the current baseline b. The objective to update the controller's parameter θ through the replay buffer is:

∇_{θ} [symbol] _{a1:t˜πθ,b˜B}[−log η_{θ}(aₜ|a_{1:t-1})(rₐ−b)₊]

Then, an empirical approximation of the above equation is:

$${L}_{replay} = \frac{1}{n} {\sum }_{k = 1}^{n} {\sum }_{t = 1}^{T} {∇}_{θ} - log {π}_{θ} ( {a}_{t} \text{\textbar} {a}_{1 \text{:} t - 1} ) {( {r}_{a} - b )}_{+} ,$$

where n is the number of different child models that the controller samples in one batch and T is the number of tokens.

Overall, the joint optimization process is specified in Algorithm 1, which consists of two phrases: the curiosity-guided search process and the self-imitation learning process. In various embodiments, the optimal model with the best performance on the validation set is utilized for the anomaly detection tasks.

Algorithm 1:

| | |
|---|---|
| 1: | Input: Input datasets Dₜᵣₐᵢₙ; D_{valid}, and search space, S. |
| 2: | Output: Optimal model with the best performance |
| 3: | Initialize parameter θ, ω; |
| 4: | Initialize replay buffer B ← Ø |
| 5: | for each iteration do |
| 6: | Perform curiosity-guided search via a LSTM controller |
| 7: | for each step t do |
| 8: | Sample an action aₜ ~ π(a_{1:t-1}; θ); |
| 9: | ω ← ω − η∇_{ω} E_{at~π}(a_{1:t-1}; θ)[L(a_{1:t-1}; ω)] ; |
| 10: | θ ← θ − η Lₑₓₚₗₒᵣₑ (Dₜᵣₐᵢₙ; θ) ; |
| 11: | r_{new}(aₜ) r(aₜ) + η D_{KL} [p(θ \| a_{1:t-1}) ∥ p(θ)] ; |
| 12: | Update controller via the new reward r_{new}(aₜ) ; |
| 13: | if the performance of aₜ on D_{valid} outperforms the actions |
| | stored in B then |
| 14: | B ← {a, r} ∪ B; Update replay buffer; |
| 15: | end if |
| 16: | end for |
| 17: | Perform self-imitation learning |
| 18: | for each step t do |
| 19: | Sample a mini-batch {a, r} from B ; |
| 20: | ω ← ω − η∇_{ω} E_{at~π}(a_{1:t-1};θ) [L(a_{1:t-1}; ω)] ; |
| 21: | θ ← θ − η L_{replay} (Dₜᵣₐᵢₙ; θ) ; |
| 22: | end for |
| 23: | end for. |

After getting the optimal solution with the best performance on the validation set, we utilize the searched architecture configuration for the downstream anomaly detection applications, including instance-level anomaly detection and pixel-level defect segmentation.

In various embodiments, the sampled architectures are trained on the training set with anomaly free settings, and update the controller on the validation set via the reward signal.

In a non-limiting exemplary embodiment, the controller RNN is a two-layer LSTM with 50 hidden units on each layer. It is trained with the ADAM optimizer with a learning rate of 3.5e-4. Weights are initialized uniformly in (−0.1, 0.1]. The search process is conducted for a total of 500 epochs. The size of the self-imitation buffer is 10. We use a tanh constant of 2.5 and a sample temperature of 5 to the hidden output. We train the sampled architectures with batch size 64 and momentum 0.9. The learning rate starts at 0.1, and is dropped by a factor of 10 at 50% and 75% of the training progress, respectively.

In various embodiments, the searched architecture successfully detected images with defect sections out of the positive samples in a more precise way. It is also observed that the searched architectures have better performance in RPRO, which indicates the search process helps the architecture focus to locate and represent the anomaly parts within each negative images, as higher per-region overlap of the segmentation results.

In various embodiments, the following five different metrics can be used to measure the effectiveness of the searched architecture.

AUROC is the Area Under the Receiver Operating Characteristic curve, which is also a threshold-independent metric. The ROC curve depicts the relationship between TPR and FPR. The AUROC can be interpreted as the probability that a positive example is assigned a higher detection score than a negative example.

AUPR is the Area under the Precision-Recall curve, which is another threshold independent metric. The PR curve is a graph showing the precision=TP/(TP+FP) and recall=TP/(TP+FN) against each other. The metric AUPR-In and AUPR-Out denote the area under the precision-recall curve where positive samples and negative samples are specified as positives, respectively.

From the results, the architectures discovered by Auto Anomaly Detection consistently outperform the handcrafted out-of-distribution detection methods with pretrain models (ODIN) and without pretrain models (MSP) in most test cases when measure by different evaluation matrix AUROC, AUPR In and AUPR Out. It indicates that AutoAD could achieve higher performance in accuracy, precision and recall simultaneously, with more precise detection rate and less nuisance alarms.

Noticeably, AutoAD consistently outperforms the baseline methods by a large margin when measure by AUROC and RPRO.

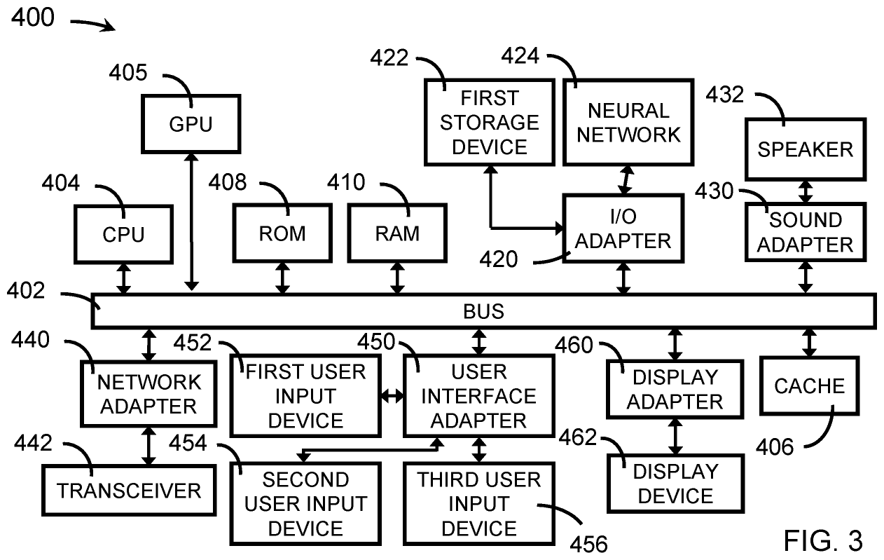

FIG. 3 is an exemplary processing system 400 to which the present methods and systems may be applied, in accordance with an embodiment of the present invention.

The processing system 400 can include at least one processor (CPU) 404 and may have a graphics processing (GPU) 405 that can perform vector calculations/manipulations operatively coupled to other components via a system bus 402. A cache 406, a Read Only Memory (ROM) 408, a Random Access Memory (RAM) 410, an input/output (I/O) adapter 420, a sound adapter 430, a network adapter 440, a user interface adapter 450, and/or a display adapter 460, can also be operatively coupled to the system bus 402.

A first storage device 422 and a second storage device 424 are operatively coupled to system bus 402 by the I/O adapter 420, where a neural network can be stored for implementing the features described herein. The storage devices 422 and 424 can be any of a disk storage device (e.g., a magnetic or optical disk storage device), a solid state storage device, a magnetic storage device, and so forth. The storage devices 422 and 424 can be the same type of storage device or different types of storage devices.

A speaker 432 can be operatively coupled to the system bus 602 by the sound adapter 430. A transceiver 442 can be operatively coupled to the system bus 602 by the network adapter 440. A display device 462 can be operatively coupled to the system bus 402 by display adapter 460.

A first user input device 452, a second user input device 454, and a third user input device 456 can be operatively coupled to the system bus 402 by the user interface adapter 450. The user input devices 452, 454, and 456 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 452, 454, and 456 can be the same type of user input device or different types of user input devices. The user input devices 452, 454, and 456 can be used to input and output information to and from the processing system 400.

In various embodiments, the processing system 400 may also include other elements (not shown), as readily contemplated by one of skill in the art, as well as omit certain elements. For example, various other input devices and/or output devices can be included in processing system 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 400 are readily contemplated by one of ordinary skill in the art given the teachings of the present principles provided herein.

Moreover, it is to be appreciated that system 400 is a system for implementing respective embodiments of the present methods/systems. Part or all of processing system 400 may be implemented in one or more of the elements of FIGS. 1 and 2. Further, it is to be appreciated that processing system 400 may perform at least part of the methods described herein including, for example, at least part of the method of FIGS. 1 and 2.

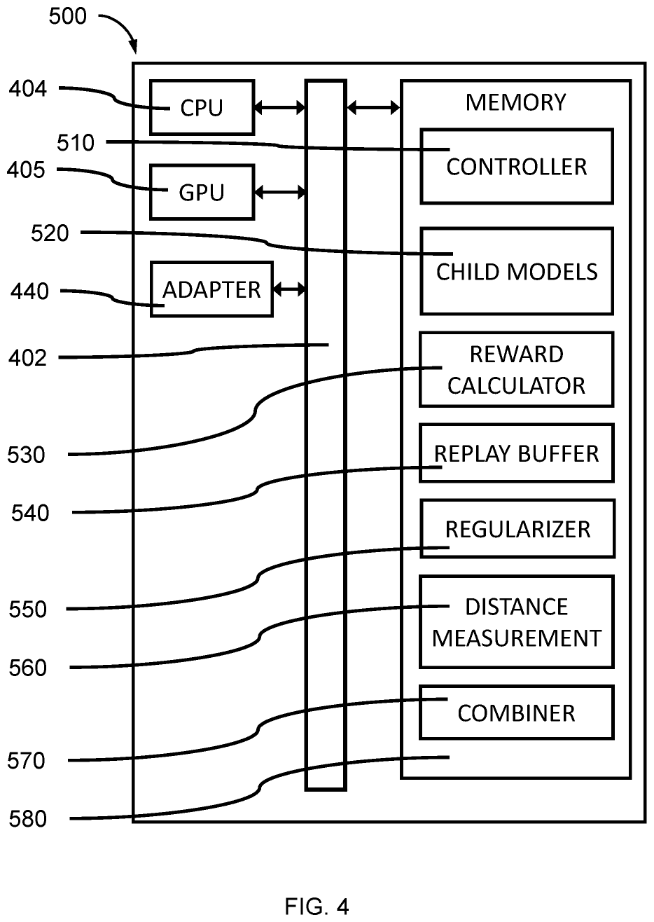

FIG. 4 is an exemplary processing system configured to implement one or more neural networks for automating the design of neural networks for anomaly detection, in accordance with an embodiment of the present invention.

In one or more embodiments, the processing system 400 can be a computer system 500 configured to perform a computer implemented method of designing and generating neural networks for anomaly detection, where an automated anomaly detection (AutoAD) framework can find an optimal neural network model architecture for a given dataset.

In one or more embodiments, the processing system 400 can be a computer system 500 having memory components 580, including, but not limited to, the computer system's random access memory (RAM) 410, hard drives 422, and/or cloud storage to store and implement a computer implemented method of automatically searching a search space for a suitable anomaly detection solution with a neural network architecture configuration for a given task. The memory components 580 can also utilize a database for organizing the memory storage.

In various embodiments, the memory components 580 can include a controller 510 that can be a neural network configured to design and generate a neural network for anomaly detection, where the controller can be a Long Short Term Memory (LSTM), and the generated neural network(s) can be autoencoders. The controller 510 can also be configured to receive as input a dataset and search a search space for suitable anomaly detection solutions. The generated neural network(s) for anomaly detection (child models) can be deep autoencoder(s) configured for a particular anomaly detection task.

In various embodiments, the memory components 580 can store a plurality of child models 520 configured for anomaly detection, where the child models can be trained and evaluated based on the input dataset(s).

In various embodiments, the memory components 580 can include a Reward Calculator 530 that is configured to implement a reward function to evaluate the generated child models 520.

In various embodiments, the memory components 580 can include an Experience Replay Buffer 540 that is configured to store the reward values generated by the Reward Calculator 530 for the corresponding child models 520.

In various embodiments, the memory components 580 can include a Regularizer 550 that is configured to introduce definition-hypothesis from the search space. The Regularizer 550 can be implemented by a child model and configured to calculate an anomaly score.

In various embodiments, the memory components 580 can include a Distance Measurement 560 that is configured to calculate a reconstruction distance. The Distance Measurement 560 can be implemented by a child model to calculate a reconstruction distance for an autoencoder.

In various embodiments, the memory components 580 can include a Combiner 570 configured to aggregate the values of the Regularizer 550 and Distance measurement 560. The Combiner 5700 can be configured to receive values from the Regularizer 550 and Distance measurement 560 to generate a score 360 for a child model trained and tested on the datasets.

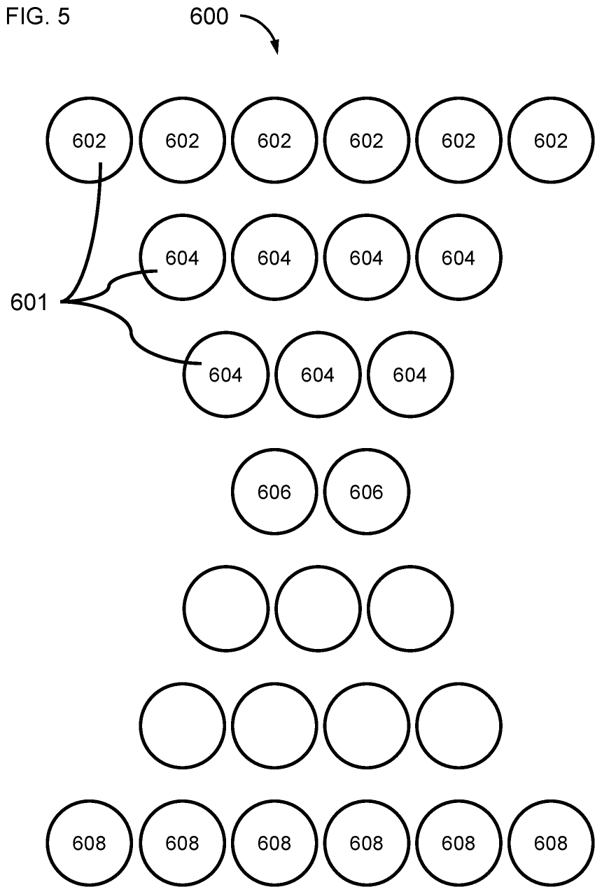

FIG. 5 is a block diagram illustratively depicting an exemplary neural network in accordance with another embodiment of the present invention.

A neural network 600 may include a plurality of neurons/nodes 601, and the nodes may communicate using one or more of a plurality of connections. The neural network 600 can be an Encoder-Decoder type of neural network that can include a plurality of layers, including, for example, an input layer 602, one or more hidden layers 604, a compressed feature layer/vector 606, and an output layer 608. In various embodiments, nodes 601 within each layer may be employed to apply a function (e.g., summation, regularization, activation, etc.) to inputs from a previous layer to produce an output, and the hidden layer 804 may be employed to transform inputs from the input layer 602 into output for nodes 601 at different levels. The number of nodes 601 per layer 602, 604, 606, 608 can depend on the number of inputs and type of output.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer implemented method for automatically generating a neural network to perform anomaly detection, comprising:
defining a search space, including parameters for neural network architectures, definition-hypothesis of an anomaly assumption, and loss functions, as a tuple;
selecting a first candidate anomaly detection architecture from the search space that defines the parameters of the neural network architecture;
feeding a data set into the neural network defined by the first candidate anomaly detection architecture, wherein the data set includes recognized anomalies for a specified anomaly detection task;
selecting a second candidate anomaly detection architecture from the search space that defines the parameters of the neural network;
feeding the data set into the neural network defined by the second candidate anomaly detection architecture;
determining a performance difference between the neural networks defined by the first candidate anomaly detection architecture and the neural network defined by the second candidate anomaly detection architecture based on the data set;
repeating the defining of the neural network with subsequent candidates of anomaly detection architectures selected from the search space; and
identifying a best anomaly detection neural network candidate selected from the search space based on the performance differences for the data set of the specified anomaly detection task.

2. The method as recited in claim 1, wherein the neural network is a deep AutoEncoder.

3. The method as recited in claim 1, wherein identifying the best sample anomaly detection candidate includes updating an experience replay buffer for sample anomaly detection candidates having a greater reward value, and amplifying the contribution of the greater reward value to calculating a loss function for identified sample anomaly detection candidates.

4. The method as recited in claim 1, wherein a posterior can be approximated for a training dataset Dₜᵣₐᵢₙ.

5. The method as recited in claim 4, wherein alternative probability densities over latent variables θ as q(θ), are approximated by minimizing a Kullback-Leibler (KL) divergence, D_{KL}.

6. The method as recited in claim 1, wherein the parameters of the neural network for the candidate anomaly detection architectures include global settings for the whole candidate anomaly detection architecture and local settings in each layer of the candidate anomaly detection architectures.

7. The method as recited in claim 6, wherein the local settings include a number of output channels, a type of pooling for each layer, a size of a kernel for a pooling operation, a normalization type, and a type of activation function.

8. The method as recited in claim 6, wherein the global settings include a definition-hypothesis that defines anomalies for an objective function and a distance measurement that measures a reconstruction distance between the data set and a reconstruction result.

9. A processing system for automatically generating a neural network to
perform anomaly detection, comprising:
one or more processor devices;
a memory in communication with at least one of the one or more processor devices; and
an automated anomaly detection (AutoAD) framework configured to:
defining a search space, including parameters for neural network architectures, definition-hypothesis of an anomaly assumption, and loss functions, as a tuple;
select a first candidate anomaly detection architecture from the search space that defines the parameters of the neural network architecture;
feed a data set into the neural network defined by the first candidate anomaly detection architecture, wherein the data set includes recognized anomalies for a specified anomaly detection task;
select a second candidate anomaly detection architecture from the search space that defines the parameters of the neural network;
feed the data set into the neural network defined by the second candidate anomaly detection architecture;
determine a performance difference between the neural networks defined by the first candidate anomaly detection architecture and the neural network defined by the second candidate anomaly detection architecture based on the data set;
repeat the defining of the neural network with subsequent candidates of anomaly detection architectures selected from the search space; and
identify a best anomaly detection neural network candidate selected from the search space based on the performance differences for the data set of the specified anomaly detection task.

10. The processing system as recited in claim 9, wherein the neural network is a deep AutoEncoder.

11. The processing system as recited in claim 9, wherein the automated anomaly detection (AutoAD) framework is further configured to identify the best sample anomaly detection candidate by updating an experience replay buffer for sample anomaly detection candidates having a greater reward value, and amplifying the contribution of the greater reward value to calculating the loss function for identified sample anomaly detection candidates.

12. The processing system as recited in claim 9, wherein a posterior can be approximated for a training dataset Dₜᵣₐᵢₙ.

13. The processing system as recited in claim 12, wherein the parameters of the neural network for the candidate anomaly detection architectures include global settings for the whole candidate anomaly detection architecture and local settings in each layer of the candidate anomaly detection architectures.

14. The processing system as recited in claim 13, wherein the local settings include a number of output channels, a type of pooling for each layer, a size of a kernel for a pooling operation, a normalization type, and a type of activation function.

15. The processing system as recited in claim 13, wherein the global settings include a definition-hypothesis that defines anomalies for an objective function and a distance measurement that measures a reconstruction distance between the data set and a reconstruction result.

16. A non-transitory computer readable storage medium comprising a computer readable program for producing a neural network for anomaly detection, wherein the computer readable program when executed on a computer causes the computer to perform:
defining a search space, including parameters for neural network architectures, definition-hypothesis of an anomaly assumption, and loss functions, as a tuple;
selecting a first candidate anomaly detection architecture from the search space that defines the parameters of the neural network architecture;
feeding a data set into the neural network defined by the first candidate anomaly detection architecture, wherein the data set includes recognized anomalies for a specified anomaly detection task;
selecting a second candidate anomaly detection architecture from the search space that defines the parameters of the neural network;
feeding the data set into the neural network defined by the second candidate anomaly detection architecture;
determining a performance difference between the neural networks defined by the first candidate anomaly detection architecture and the neural network defined by the second candidate anomaly detection architecture based on the data set;
repeating the defining of the neural network with subsequent candidates of anomaly detection architectures selected from the search space; and
identifying a best anomaly detection neural network candidate selected from the search space based on the performance differences for the data set of the specified anomaly detection task.

17. The computer readable program as recited in claim 16, wherein the neural network is a deep AutoEncoder.

18. The method as recited in claim 16, wherein identifying the best sample anomaly detection candidate includes updating an experience replay buffer for sample anomaly detection candidates having a greater reward value, and amplifying the contribution of the greater reward value to calculating the loss function for identified sample anomaly detection candidates.

19. The method as recited in claim 16, wherein the parameters of the neural network for the candidate anomaly detection architectures include global settings for the whole candidate anomaly detection architecture and local settings in each layer of the candidate anomaly detection architectures.

20. The method as recited in claim 19, wherein the local settings include a number of output channels, a type of pooling for each layer, a size of a kernel for a pooling operation, a normalization type, and a type of activation function, and wherein the global settings include a definition-hypothesis that defines anomalies for an objective function and a distance measurement that measures a reconstruction distance between the data set and a reconstruction result.
